(19) United States
(12) Patent Application Publication
(10) Pub. No.: US 2006/0154019 A1
(43) Pub. Date: Jul. 13, 2006

(54) Hook component structure of Velcro fastening strap

(75) Inventor: Kuo Yen Cheng, Hemei Town (TW)

Correspondence Address: TROXELL LAW OFFICE PLLC;Suite 1404, 5205 Leesburg Pike, Falls Church, VA, 22041, US

(73) Assignee: Spring Rich Limited

(21) Appl. No.: 11/033,284

(22) Filed: Jan. 12, 2005

(51) Int. Cl. B32B 3/06

(52) U.S. Cl. 428/100

(57) ABSTRACT

A hook component structure of a Velcro fastening strap includes a hook component molded in a mushroom-like shape and made up of a base section, a tapered neck portion extending upwards from the base section thereof, and a pair of arcuate hook elements symmetrically bifurcating outwards from both sides of the neck portion with an escape notch indented in the middle there-between wherein the hook element is equipped with an arcuate hook end, and a flattened arc recess defining the lower edge thereof. Via the structure above, loop components can be easily and in a large amount attached to the flattened arc recess of the acrcuate hook elements therein as well as peeled off there-from in an effort-saving manner. Besides, the hook component with the arcuate hook elements bifurcating outwards from both sides of the neck portion can provide stronger fastening support to the loop component attached thereto so that the loop component will not easily get torn apart there-from when affected by a horizontal pulling force. And the hook components can also be economically arranged at a Velcro strap thereon so as to reduce the cost of production thereof

### BACKGROUND OF THE INVENTION

The present invention is related to a hook component structure of a Velcro fastening strap, including a hook component molded in a mushroom-like shape and made up of a tapered neck portion extending upwards from a base section, and a pair of arcuate hook elements symmetrically bifurcating outwards from both sides of the neck portion with an escape notch indented there-between wherein the hook element has an arcuate hook end and a flattened arc recess defining the lower edge thereof Via the structure above, loop components can be easily and in a large amount attached to the flattened arc recess of the acrcuate hook elements therein as well as peeled off there-from with little effort required, and the arcuate hook elements extending at both sides of the hook component thereof can provide stronger fastening support to the loop components against horizontal pulling force applied thereto. Besides, the hook components can also be economically arranged to reduce the cost of material and production thereof.

Please refer to FIGS. 6, 6-A. A conventional hook component structure of a Velcro fastening strap is molded in a mushroom-like shape and made up of a base section 11 narrowed upwards to form a neck portion 12, and a pair of column-like annular hook elements 13 bifurcating outwards from both sides of the neck portion 12 thereof with an escape notch 14 defining the middle section there-between. The annular hook element 13 is provided with an annular hook end 15 curving downwards at the end thereof, and an annular indent recess 16 defining the lower edge thereof There are some drawbacks to such conventional hook component structure above. The distance D from the top edge of the annular indented recess 16 to the bottom edge of the annular hook end 15 is rather long, and, as a result, larger pulling force must be applied to loop components 40 attached to the hook component 10 so as to peel off the loop components 40 there-from. Second, the annular hook element 13, annular hook end 15, and annular indented recess 16 are all designed in circular shapes, which, though providing better support to resist horizontal pulling force, is difficult for the loop components 40 to get attached at the interior of the annular indented recess 16 in a large amount and, thus, to completely strength up against the horizontal pulling force applied thereto. Third, the distance A from the base section 11 to the top edge of the annular hook element 13, the distance B from the base section 11 to the top edge of the annular indented recess 16, the distance C from the base section 11 to the bottom edge of the annular hook end 15, the distance D from the top edge of the annular indented recess 16 to the bottom edge of the annular hook end 15, the width of the base section 11 E, the thickness of the hook component 10 F, the width of the neck portion 12 G, and the distance H from the top edge of the annular hook element 13 to the top edge of the annular indented recess 16, all from A to H measure a rather big number so that more material is required and the cost of production is uneconomically boosted. Fourth, the distance A from the base section 11 to the top edge of the annular hook element 13 is rather high. When a loop component 40 is attached to the hook component 10 thereof, the thickness of the Velcro fastening strap formed thereby is augmented with that of the loop component 40 itself and A, which can easily get interfered by external objects.

Please refer to FIGS. 7, 7-A. A second conventional hook component structure of a Velcro fastening strap is made up of a hook component molded in a slant L shape, having a neck portion 22 tapered upwards from a base section 21, and a pointed arcuate hook element 23 curving outwards at one side of the neck portion 22 thereof. The pointed arcuate hook element 23 has a pointed arcuate hook end 24 disposed at the one end thereof and an oval indented recess 25 defining the lower edge thereof Please refer to FIGS. 7-B, 7-C. There are some disadvantages to the second hook component structure thereof First, the distance D′ from the top edge of the oval indented recess 25 to the bottom edge of the pointed arcuate hook end 24 is deep in length, and the distance H′ from the top edge of the pointed arcuate hook element 23 to the top edge of the oval indented recess 25 is big. Therefore, larger pulling force must be applied to the loop component 40 attached to the hook component 20 so as to peel off the loop component 40 there-from. Second, the distance D′ from the top edge of the oval indented recess 25 to the bottom edge of pointed arcuate hook end 24 is rather deep, and, as a result, the loop component 40 is difficult to get attached to the interior of the oval indented recess 25 thereof in a large amount and to efficiently resist the horizontal pulling force applied thereto. Third, the width of the neck portion 22 as marked by G′ is narrow without any escape notches defined thereon, which makes it more vulnerable to horizontal pulling force. As a result, the loop component 40 attached thereto tends to be more easily peeled off from the hook component 20 by big horizontal pulling force applied thereto.

### SUMMARY OF THE PRESENT INVENTION

It is, therefore, the primary purpose of the present invention to provide a hook component structure of a Velcro fastening strap, including a hook component molded in a mushroom-like shape and made up of a base section, a tapered neck portion extending upwards from the base section thereof, and a pair of arcuate hook elements symmetrically bifurcating outwards from both sides of the neck portion with an escape notch indented there-between wherein the hook element has a partly-circular and partly-flattened arcuate hook end and a flattened arc recess defining the lower edge thereof so that loop components can be easily and in a large amount attached to the flattened arc recess of the acrcuate hook elements therein as well as speedily peeled off there-from with little effort required, efficiently strengthening the loop components from being affected by horizontal pulling force applied thereto and facilitating an effort-saving release of the hook component thereof.

It is, therefore, the second purpose of the present invention to provide a hook component structure of a Velcro fastening strap wherein the arcuate hook elements symmetrically extending at both sides of the hook component thereof can mutually support each other and strengthen the loop component attached thereto when affected by a horizontal pulling force so that the loop component will not easily get torn apart there-from by big pulling force applied thereto.

It is, therefore, the third purpose of the present invention to provide a hook component structure of a Velcro fastening strap wherein the hook components can be evenly arranged at a Velcro strap thereon in a rather sparse manner so as to economically reduce the cost of material and production thereof and thus promote the competitive power thereof.

It is, therefore, the fourth purpose of the present invention to provide a hook component structure of a Velcro fastening strap wherein the height of the hook component is shorter, and, thus, the Velcro strap formed by the loop component attached to the hook component thereof is thinner so as to avoid the interference of external objects.

### BRIEF DESCRIPTION OF THE DRAWINGS

FIG. 1 is a front side view of the present invention with loop components attached thereto in use.

FIG. 1-A is a lateral view of the present invention.

FIGS. 2, 2-A, 2-B are diagrams showing the present invention in contrast to two prior arts in terms of the distance and shape of different sections thereof.

FIGS. 3, 3-A, 3-B are diagrams showing front side views of the present invention in contrast to the two prior arts that are respectively arranged within a same area.

FIGS. 4, 4-A, 4-B are diagrams showing upper lateral views of the present invention in contrast to the two prior arts that are respectively arranged within a same area.

FIGS. 5, 5-A, 5-B are diagrams showing top views of the present invention in contrast to the two prior arts that are respectively arranged within a same area.

FIG. 6 is a front side view of the first conventional hook component structure with loop components attached thereto in use.

FIG. 6-A is a lateral view of the first convention hook component structure thereof.

FIG. 7 is a front side view of the second conventional hook component structure.

FIG. 7-A is a lateral view of the second conventional hook component structure.

FIG. 7-B is a diagram showing the second conventional hook component with a loop component attache thereto and affected by a horizontal pulling force in use.

FIG. 7-C is a diagram showing the second conventional hook component with the loop component attached thereto that is peeled off there-from in use.

### DETAILED DESCRIPTION OF THE PREFERRED EMBODIMENTS

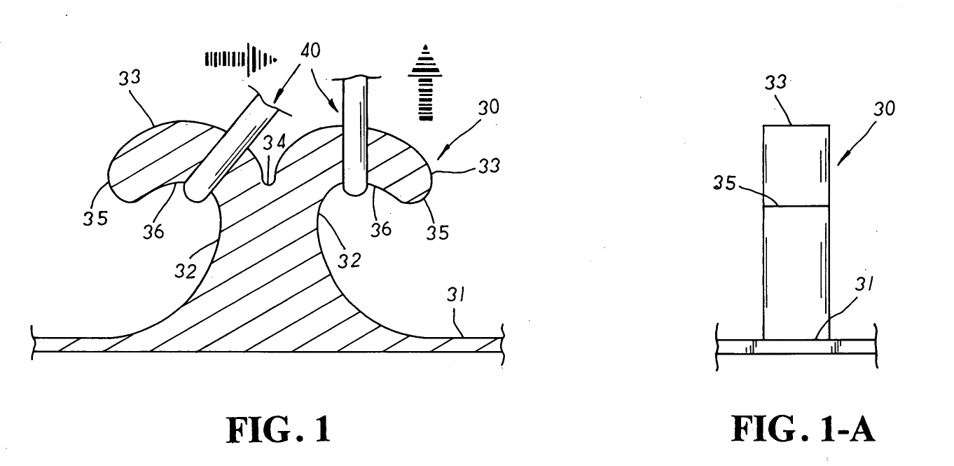

Please refer to FIGS. 1 to 1A inclusive. The present invention is related to a hook component structure of a Velcro fastening strap, including a hook component 30 molded in a mushroom-like shape and made up of a base section 31, a tapered neck portion 32 extending upwards from the base section 31 thereof, and a pair of partly-circular and partly-flattened arcuate hook elements 33 symmetrically bifurcating outwards from both sides of the tapered neck portion 33 with an escape notch 34 indented in the middle there-between. The arcuate hook element 33 is equipped with a partly-circular and partly-flattened arcuate hook end 35, and a nearly flattened arc recess 36 defining the lower edge thereof Both the distance from the top edge of the flattened arc recess 36 to the bottom edge of the arcuate hook end 35, and that from the top edge of the arcuate hook element 33 to the top edge of the flattened arc recess 36 are shorter and characterized by an elongated flattened arch that can facilitate the attachment therein and the peeling-off there-from of a loop component 40.

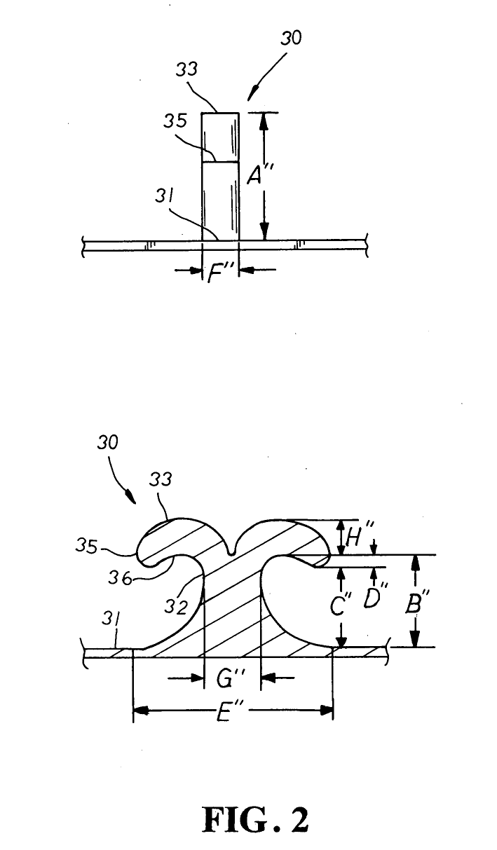

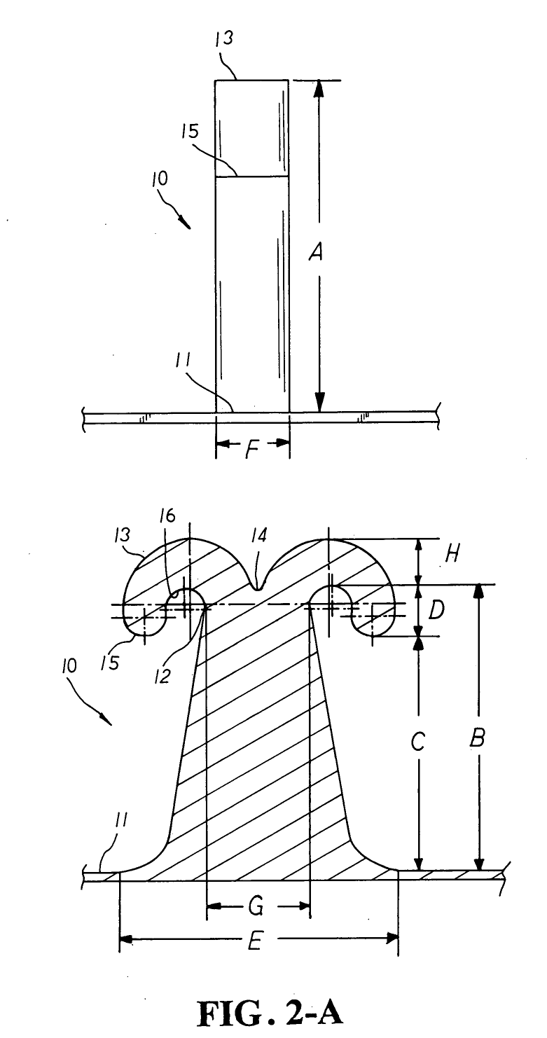

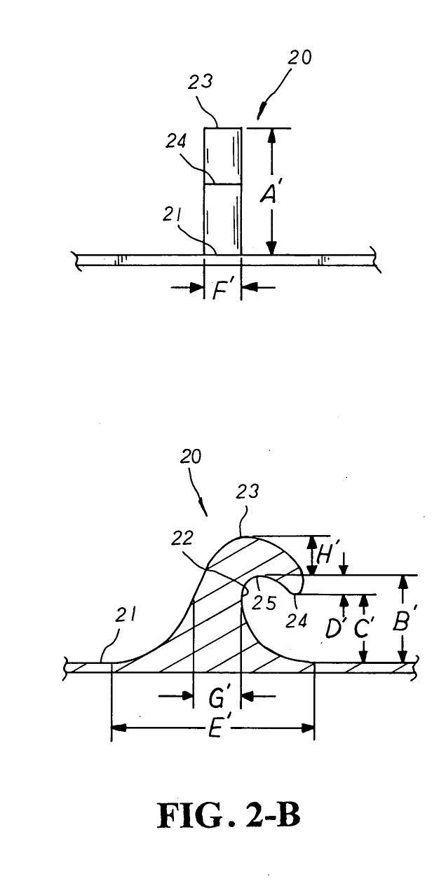

Please refer to FIGS. 2, 2A, and 2B, showing the distance and size of different sections of the present invention in contrast to those of the first and the second conventional hook component structure above.

The distance from the base section 31 to the top edge of the arcuate hook element 33 is marked by A″ (the first conventional one is by A and the second conventional one by A′).

The distance from the base section 31 to the top edge of the flattened arc recess 36 is marked by B″ (the first conventional one is by B and the second conventional one by B′).

The distance from the base section 31 to the bottom edge of the arcuate hook end 35 thereof is marked by C″ (the first conventional one is by C and the second conventional one by C′).

The distance from the top edge of the flattened arc recess 36 to the bottom edge of the arcuate hook end 35 is marked by D″ (the first conventional one is by D and the second conventional one by D′).

The width of the base section 31 is marked by E″ (the first conventional one is by E, and the second conventional one by E′).

The thickness of the hook component 30 is marked by F″ (the first conventional one is by F, and the second conventional one by F′).

The width of the neck portion 32 is marked by G″ (the first conventional one is by G, and the second conventional one by G′).

The distance from the top edge of the arcuate hook element 33 to the top edge of the flattened arc recess 36 is marked by H″ (the first conventional one is by H, and the second conventional one by H′).

The distance of different sections of the present invention is compared with that of the first conventional hook component as follows,

First, D>D″. The hook end of the conventional hook component is molded into an downwardly extending annular shape, while the arcuate hook end 35 is featured by an elongated and flattened arc so that the loop component 40 can be easily peeled off from the hook component 30 with little efforts.

Second, A, B, C, D, E, F, G, H>A″, B″, C″, D″, E″, F″, G″, H″. Therefore, the present invention requires relatively fewer material in production, economically saving the cost of production of the hook component 30 thereof.

Third, A>A″. The hook element of the conventional hook component above is curved downwards in an annular shape in contrast to the elongated flattened arc featured by the arcuate hook element 33 of the present invention. Therefore, the Velcro strap formed by the loop component 40 attached to the hook component 30 thereof is comparatively thinner so as to reduce the contact with other external objects and thus the interference caused thereby.

The present invention is compared with the second conventional hook component structure as follows;

First, B″>B′, C″>C′, D″<D′, H″<H′. The hook element of the second conventional hook component slants downwards into a pointed arcuate shape, while the arcuate hook element 33 is featured by an elongated and flattened arc. Therefore, the loop component 40 is much easier to get attached to the arcuate hook element 33 of the hook component 30 therein, and the number of the loop component 40 fastened to the flattened arc recess 36 is comparatively increased so that the loop component 40 will not be easily tom apart from the hook component 30 by horizontal pulling force.

Second, G″>G′. The neck portion of the second conventional hook component is narrowed upwards and tilted into an oblique angle at one side, while the neck portion 32 of the present invention is tapered upwards to extend widespread at both sides before symmetrically bifurcating into two arcuate hook elements 33 thereof so as to provide better support against horizontal pulling force. Therefore, the loop component 40 will not be easily peeled off from the hook component 30 when affected by a horizontal pulling force applied thereto.

Third, H″<H′. The hook element of the second conventional hook component is disadvantaged by a pointed arcuate shape in contrast to the elongated flattened arc of the arcuate hook element 33 of the present invention. Thus, the loop component 40 can be easily and speedily peeled off from the hook component 30 of the present invention with little efforts.

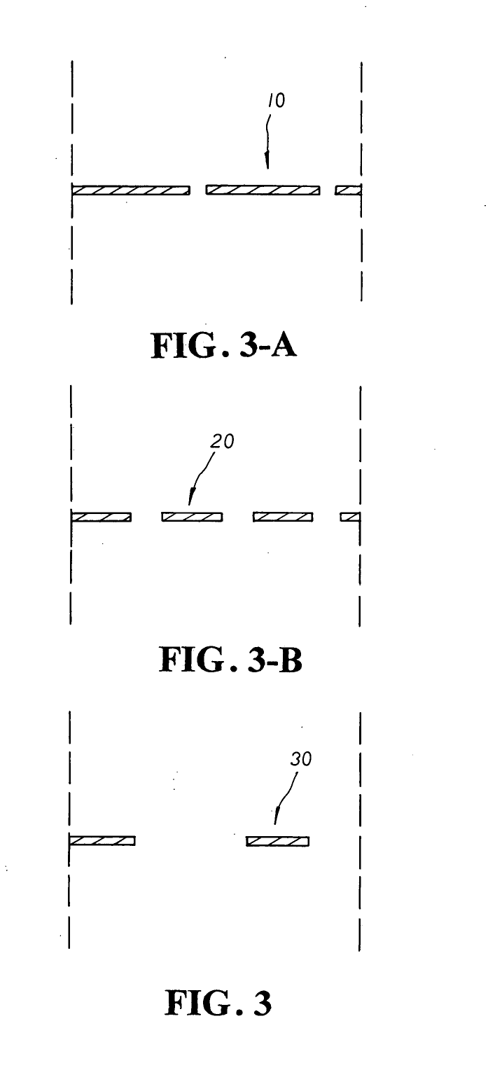

Please refer to FIGS. 3, 3-A, 3-B showing a front side view of the hook component of the present invention in contrast to those of the above first and second conventional prior arts thereof. A same limited area is taken out from the Velcro strap formed by the present invention and the above two prior arts thereof respectively, and differences among them are shown in terms of linear strips. In the case of the first prior art, two and a little bit more hook components 10 are evenly distributed within the area as shown in FIG. 3-A, and the second prior art requires three and a little bit more hook components 20 to fill the area thereof as shown in FIG. 3-B. However, only two hook components 30 are arranged within the same area as viewed from the front thereof Thus, the present invention with fewer material required can economically reduce the cost of production and provide better using effect thereof.

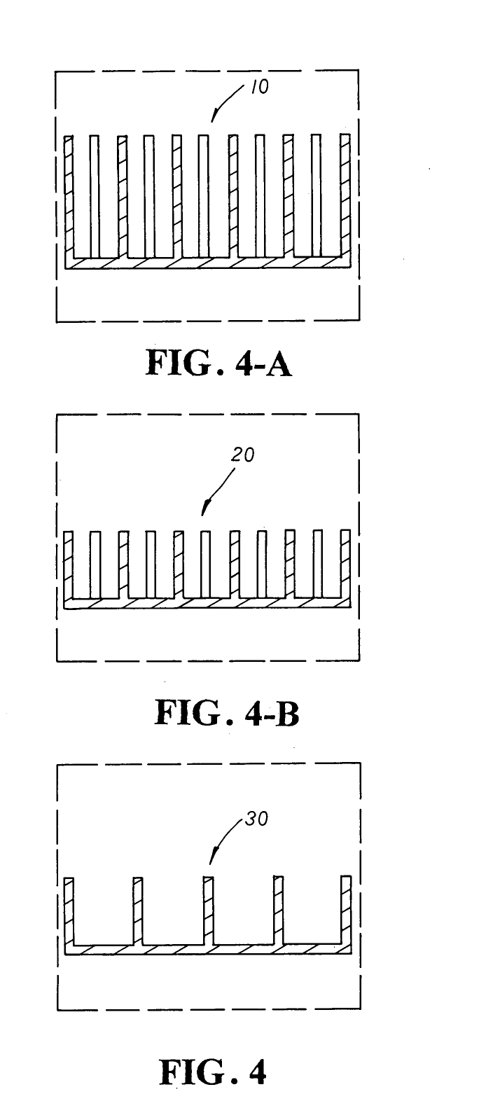

Please refer to FIGS. 4, 4-A, 4-B showing a lateral view of the present invention in contrast to those of the two conventional hook component structures wherein the hook components thereof are respectively arranged in difference interval within the same limited area and shown in term of linear strips. Six of the first and the second conventional hook components 10, 20 are respectively juxtaposed within the same area as shown in FIGS. 4-A, 4-B, while only five hook components 30 are required to occupy the same area thereof as viewed from a lateral side thereof Thus, the present invention can economically save the cost of material and achieve better using effect thereof.

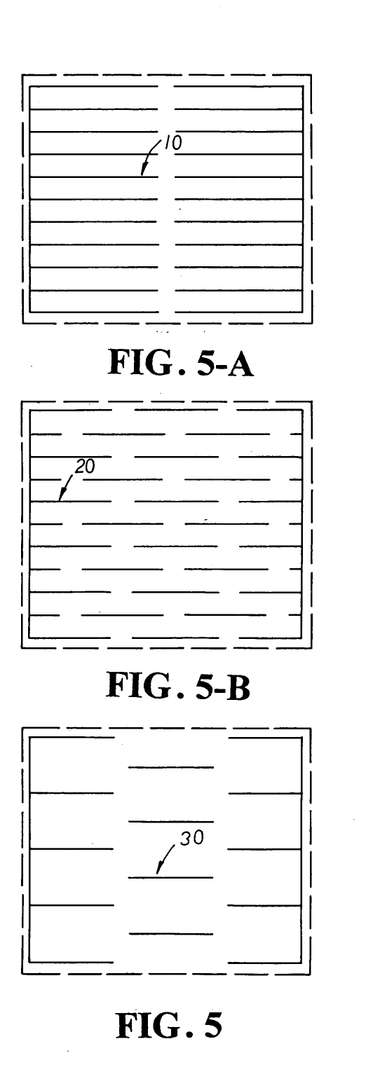

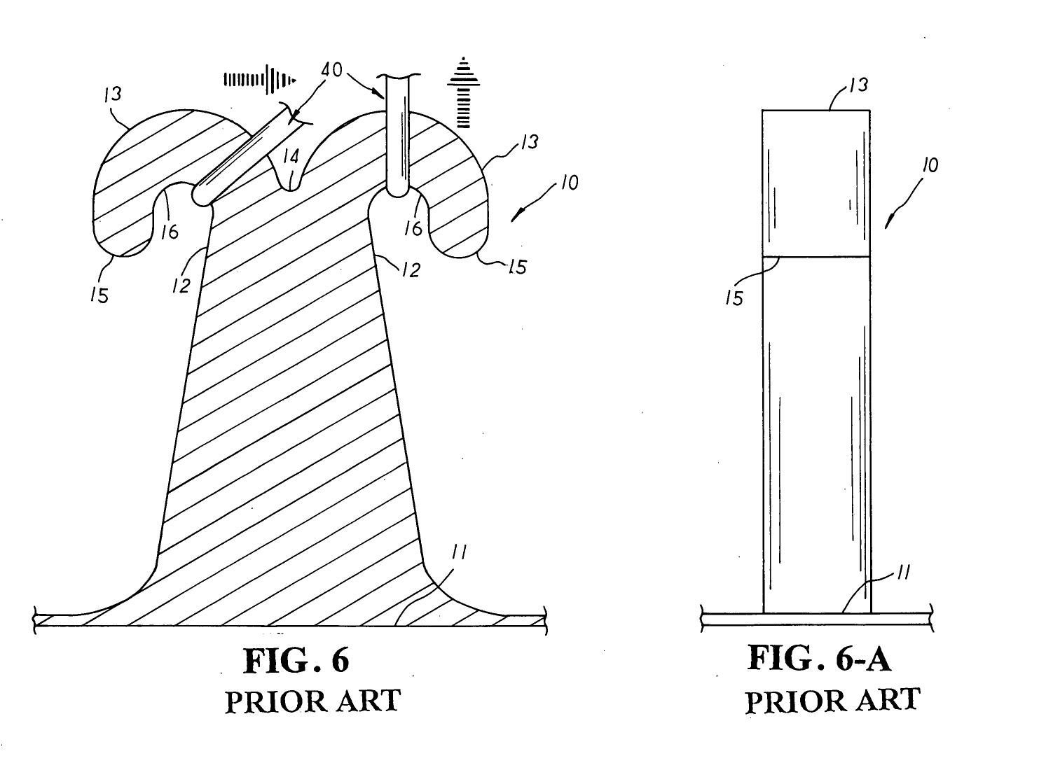

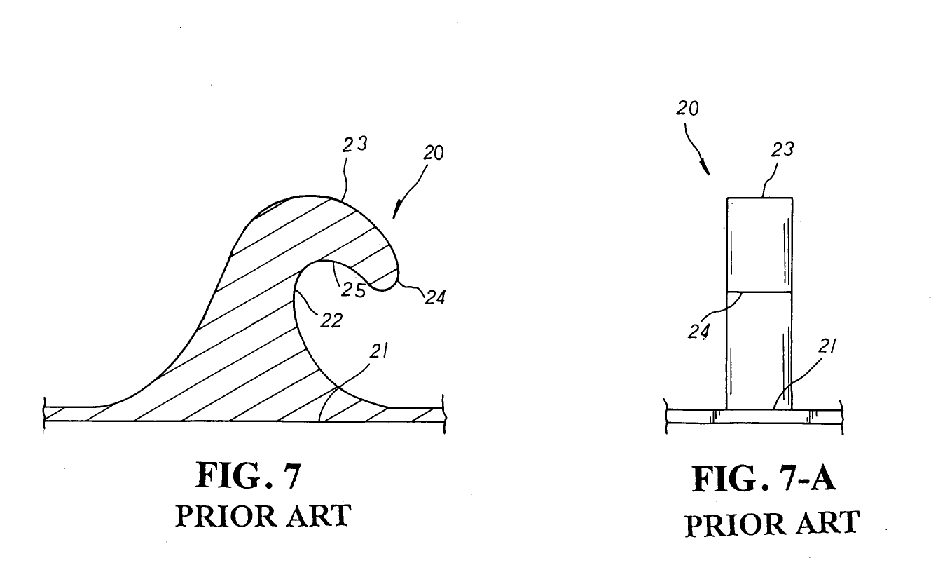

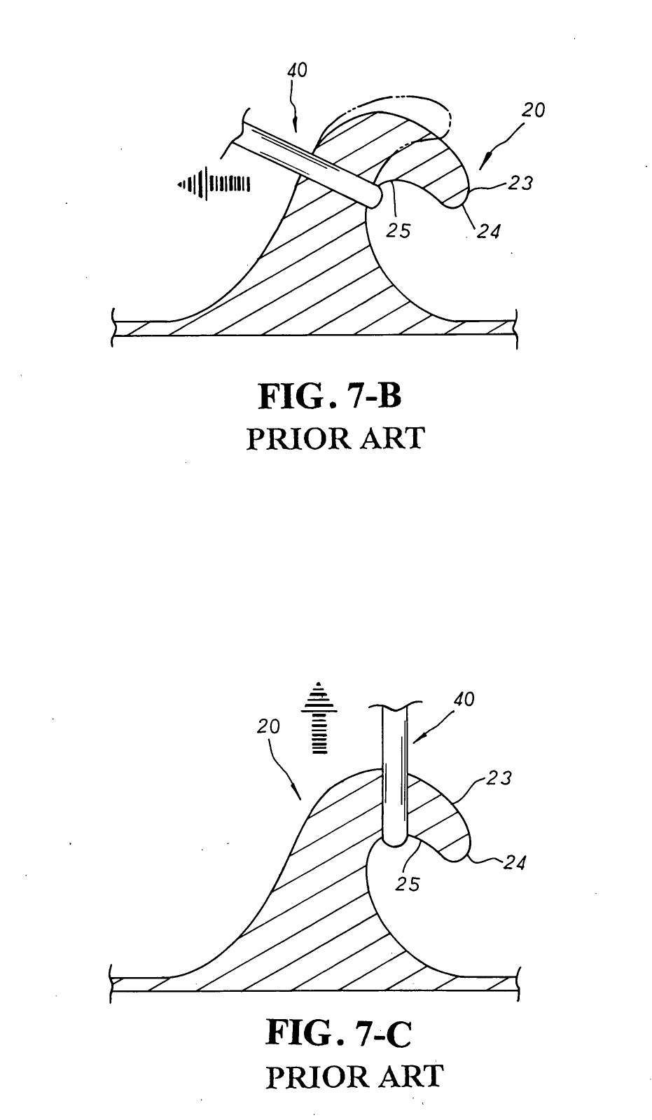

Please refer to FIGS. 5, 5-A, 5-B showing the present invention in contrast to the above two conventional hook component structures thereof wherein the hook components thereof are respectively arranged in different interval and manner within a same limited area and shown in linear strips as viewed from a top side thereof. The first convention hook components 10 are densely and evenly juxtaposed one to another with little base area revealed therein as shown in FIG. 5-A, while the second hook components 20 are closely and alternatively arranged thereon with no more base area disclosed like the previous one as shown in FIG. 5-B. In contrast, the hook components 30 of the present invention are neatly distributed within the same area thereof in a relatively sparse manner and with more base area shown thereby. Thus, number of the hook component 40 required in application can be economically reduced so as to save more material and cut the cost of production without sacrificing the using effect thereof.

Therefore, the hook component structure of the present invention is characterized by several advantages. First, the depth of D″ is shorter so that the loop component 40 is easier and in a larger amount to get attached to the flattened arc recess 36 therein and peeled off there-from with little effort required. Second, the arcuate hook elements 33 symmetrically bifurcating outwards from the neck portion 32 at both sides thereof and molded in elongated flattened arc shapes can mutually support each other and strengthen the loop component 40 attached thereto so that the loop component 40 will not easily get torn apart there-from when affected by a horizontal pulling force applied thereto. Third, the hook components 30 are economically arranged at the Velcro strap thereon so as to efficiently save the material and reduce the cost of production thereof Fourth, the height of A″ is shorter so that the Velcro strap formed by the loop component 40 attached to the hook component 30 thereof is thinner and not easy to be interfered by other external objects.

What is claimed is:

1. A hook component structure of a Velcro fastening strap, including a hook component molded in a mushroom-like shape and made up of a base section, a tapered neck portion extending upwards from the base section thereof, and a pair of hook elements symmetrically bifurcating outwards from both sides of the neck portion with an escape notch indented in the middle there-between; the present invention being characterized by that,
the hook element, molded in an arcuate shape, being equipped with an arcuate hook end, and a flattened arc recess defining the lower edge thereof wherein both the distance from the top edge of the flattened arc recess to the bottom edge of the arcuate hook end, and that from the top edge of the arcuate hook end and the top edge of the flattened arc recess is relatively shorter;
via the structure above, the hook components arranged at a Velcro strap thereon can be economically reduced in number so as to save the cost of production, and loop components can be easily and in a large amount attached to the interior of the flattened arc recess thereof as well as peeled off there-from with little effort required; moreover, the hook component with the arcuate hook elements bifurcating outwards from both sides of the neck portion can provide stronger fastening support to the loop component attached thereto so that the loop component will not easily get torn apart there-from when affected by a horizontal pulling force.

2. The hook component structure of a Velcro fastening strap according to claim 1 wherein the arcuate hook element of the hook component thereof is molded in a partly-circular and partly-flatten curved shape, and the hook end of the hook element thereof is also figured by a partly-circular and partly-flatten arcuate end; besides, the arc recess defining the lower edge of the hook element thereof is made in a flattened arcuate surface so that the loop component can easily get attached therein as well as peeled off there-from in an effort-saving manner.
